(19) United States
(12) Patent Application Publication
(10) Pub. No.: US 2023/0339657 A1
(43) Pub. Date: Oct. 26, 2023

(54) TUBE AND METHOD FOR CLOSING A TUBE

(71) Applicant: IWK Verpackungstechnik GmbH, Stutensee (DE)

(72) Inventors: Matthias KIRSTEN, Eggenstein-Leopoldshafen (DE); Dirk MATTHAEUS, Karlsruhe (DE)

(73) Assignee: IWK Verpackungstechnik GmbH, Stutensee (DE)

(21) Appl. No.: 18/137,670

(22) Filed: Apr. 21, 2023

(30) Foreign Application Priority Data
Apr. 21, 2022 (DE) 10 2022 109 695.5

(51) Int. Cl. B65D 35/44; B65D 35/10

(52) U.S. Cl. CPC B65D 35/44; B65D 35/10

(57) ABSTRACT

A tube, including a tube body, which has a tube shoulder on a first axial end and is closed on an opposite second axial end, in that opposite sections of a tube wall of the tube body are welded to each other in a closure region. The closure region is folded over on a first fold edge in such a way that it is divided into an unfolded base section connected to the tube body and a foldover section. The foldover section is glued to the unfolded base section of the closure region.

This nonprovisional application claims priority under 35 U.S.C. § 119(a) to German Patent Application No. 10 2022 109 695.5, which was filed in Germany on Apr. 21, 2022, and which is herein incorporated by reference.

### BACKGROUND OF THE INVENTION

### Field of the Invention

The present invention relates to a tube, including a tube body, which has a tube shoulder on a first axial end and is closed on an opposite second axial end, in that opposite sections of a tube wall of the tube body are welded to each other in a closure region.

The invention furthermore relates to a method for closing a tube, which includes a tube body, opposite sections of a tube wall of the tube body being welded to each other in a closure region.

### Description of the Background Art

Tubes of the mentioned structure have long been known. The tube body is formed from a cylindrical tubing made of plastic, which is provided with an, in particular, prefabricated tube shoulder on its first axial end, which is also made of plastic. A closing flap, a cover, or another closure element may be arranged on the tube shoulder.

The tube is initially open on the second axial end opposite the tube shoulder, where it may be filled with a desired product, for example a cream. After filling the product, the tube body is heated on its second axial end by hot air and/or ultrasound and/or laser beams or in another manner to the extent that the plastic material of the tube body is at least superficially melted. The tube body is then pressed together on its second axial end perpendicularly to its longitudinal extension, by which means opposite sections of the tube wall of the tube body come into contact with each other and are welded due to the melted-on plastic material.

Attempts have been made to reduce the quantity of plastic material used for a tube, in that the tube body is not made entirely of plastic but rather of a paper which is coated with a thin plastic layer at least on one side and, in particular, on the inside. To close the tube, the thin plastic layer is heated in the aforementioned manner in the region of the second axial end, after which opposite sections of the tube wall of the tube body are pressed together. However, it has been shown that the welded joint of the plastic-coated paper of the tube body may come apart if an excessive pressure force is applied to the tube body from outside by a user, thus increasing the internal pressure in the interior of the tube body. As a result of this increased internal pressure, the welded joint may come apart, by which means the product inside the tube spurts out.

### SUMMARY OF THE INVENTION

It is therefore an object of the present invention to provide a tube, which remains securely closed even if the tube body is not made of plastic or only of a small amount thereof. In addition, a method for closing a corresponding tube is to be provided, which may be carried out quickly and easily.

With regard to the tube, this object is achieved by a tube in that the closure region can have a weld seam that is folded over on a first fold edge in such a way that the closure region is divided into an unfolded base section connected to the tube body and a foldover section, and the foldover section is glued only to the unfolded base section of the closure region.

The tube can be welded in the closure region on its second axial end, on the one hand, and the closure region is additionally folded over for this purpose, on the other hand, and the foldover section formed thereby is additionally glued to the closure region. It has been shown that this double closure of the tube is sufficient even if a multilayer material is used as the material for the tube body, not all layers of which are weldable. It is provided that the foldover section is connected only to the unfolded base section of the closure region and not to the outer wall of the tube body outside the closure region.

The tube body or its tube wall can have a first layer made of paper, which is coated with a second layer of plastic at least on one side and, in particular, on the inside of the tube body. For this purpose, it may additionally be provided that the first layer of paper is also coated with a third layer of plastic on the outside, polyethylene preferably being used as the plastic.

The double closure of the tube according to the invention makes it possible to greatly limit the thickness of the inner second layer of plastic. It is preferably provided that the thickness of the second layer can be in the range of 3 μm to 8 μm and, in particular, in the range of 4 μm to 6 μm.

After the closure region has been formed by welding, the closure region can be folded over on the first fold edge preferably by 180°, so that the folded foldover section of the closure region is situated next to the unfolded base section of the closure region. The foldover section is subsequently glued to the unfolded base section of the closure region, a hot glue preferably being able to be used as the adhesive. The foldover section is thus connected only to the unfolded base section of the closure region and not to the outer wall of the tube body outside the closure region.

The foldover section can be additionally folded over on a second fold edge in such a way that the foldover section is divided into a foldover base section connected to the first fold edge and a foldover end section. The foldover end section and/or the foldover base section may be glued to the unfolded base section of the closure region.

The foldover end section of the foldover section can be arranged between the foldover base section and the base section of the closure region. In this embodiment, three regions of the tube body are situated one on top of the other, namely the base section of the welded closure region, the foldover end section of the foldover section, and the foldover base section of the foldover section.

The foldover end section can run in parallel or substantially in parallel to the foldover base section, i.e., the foldover section is folded over by 180° in the region of the second fold edge.

The foldover end section of the foldover section can be arranged between the foldover base section and the base section of the closure region.

In many cases, it is sufficient to glue the foldover end section to the unfolded base section of the closure region. In an example, it may be provided that the foldover end section is additionally glued to the foldover base section.

With regard to the method for closing a tube, the aforementioned object is achieved in that the closure region of the tube body is folded over on a first fold edge after welding in such a way that the closure region is divided into an unfolded base section connected to the tube body and a foldover section, and the foldover section is glued to the unfolded base section of the closure region.

A so-called tube blank of the usual construction may be used. The tube blank has a cylindrical, tubular tube body, which is provided with a tube shoulder on its first axial end, onto which a closure element may be placed. The tube body is preferably made up of a paper layer, which is coated with a plastic layer at least on the inside. After the tube is filled, the tube is welded in the usual manner on its second axial end facing away from the tube shoulder by applying thermal energy, softening the plastic, and pressing together opposite sections of the tube wall of the tube body in a closure region.

At the end of the welding operation, the closure region can be folded over by 180° on a first fold edge in such a way that the closure region is divided into an unfolded base section connected to the tube body and a foldover section. After or during the folding over of the foldover section, the foldover section is glued to the unfolded base section of the closure region, preferably with the aid of a hot glue. It is provided that the foldover section is connected only to the unfolded basic section of the closure region and not to the outer wall of the tube body outside the closure region. After curing the adhesive bond, the tube is closed in a dual manner, namely by welding the tube wall in the closure region, on the one hand, and by gluing the foldover section, on the other hand.

To reinforce the closure, in may be provided that the foldover section is additionally folded over on a second fold edge in such a way that the foldover section is divided into a foldover base section connected to the first fold edge and a foldover end section. During or after the formation of the second fold edge, the foldover end section is glued to the unfolded base section of the closure region, in particular with the aid of a hot glue. The foldover of the foldover section on the second fold edge may be carried out in such a way that the folded foldover end section of the foldover section is arranged between the foldover base section and the base section of the closure region.

It may be additionally or alternatively provided that the foldover end section can be glued to the foldover base section, preferably with the aid of a hot glue.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic view of the components of a tube in an extended representation;

FIG. 2 shows a schematic representation, not to scale, of section II-II in a first phase of the method;

FIG. 3 shows a representation corresponding to FIG. 2 in a second phase of the method;

FIG. 4 shows a representation corresponding to FIG. 3, with an example of the tube or the method; and

FIG. 5 shows a refinement of the tube or the method according to FIG. 4.

### DETAILED DESCRIPTION

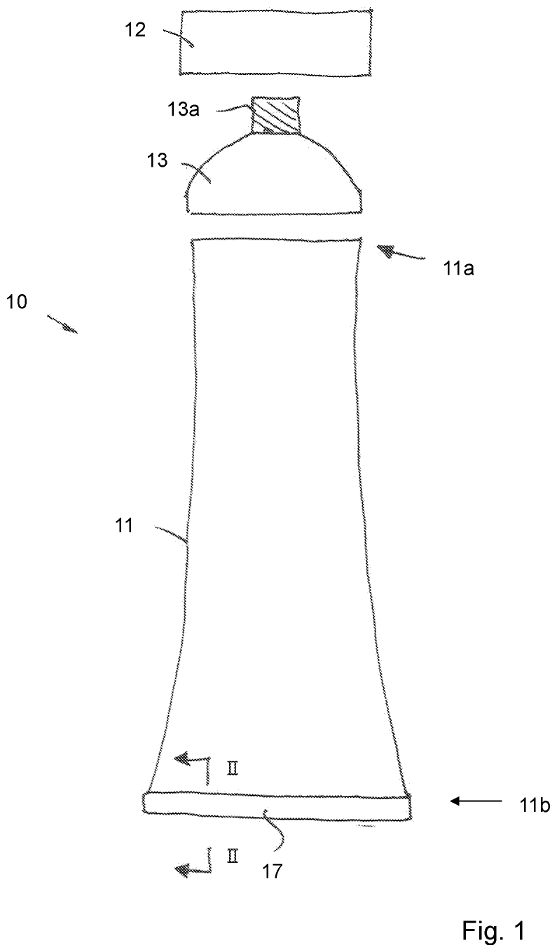

FIG. 1 shows an extended representation of the individual parts of a tube 10. Tube 10 has a tubular tube body 11, which is provided with a tube shoulder 13 on a right first end 11 a according to FIG. 1. Tube shoulder 13 may be prefabricated from plastic and be connected to tube body 11. In the illustrated exemplary embodiment, tube shoulder 13 includes a thread 13a, which may be screwed onto a closing cap 12.

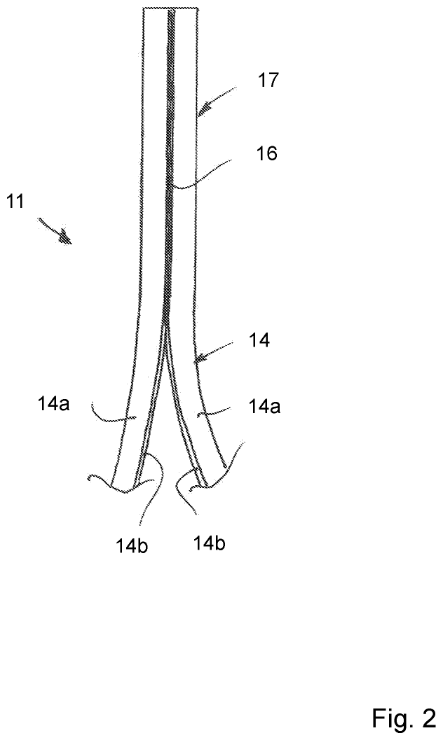

Tube body 11 is closed in a closure region 17 on opposite, left second axial end 11 b according to FIG. 1. Details of closure region 17 are apparent from FIG. 2.

According to FIG. 2, a tube wall 14 of tube body 11 is provided with a multilayer construction and has a first layer 14a made of paper, to which a second layer 14b made of plastic is attached on the inside. The plastic of second layer 14b is heated by means of hot air or ultrasound or laser or in another manner in the region of second axial end 11 b to the extent that the plastic of second layer 14b at least superficially melts. Opposite sections of melted-on tube wall 14 of tube body 11 are then pressed against each other in such a way that the melted-on sections of second layer 14b are welded to each other, forming a weld seam 16. This state is shown in FIG. 2.

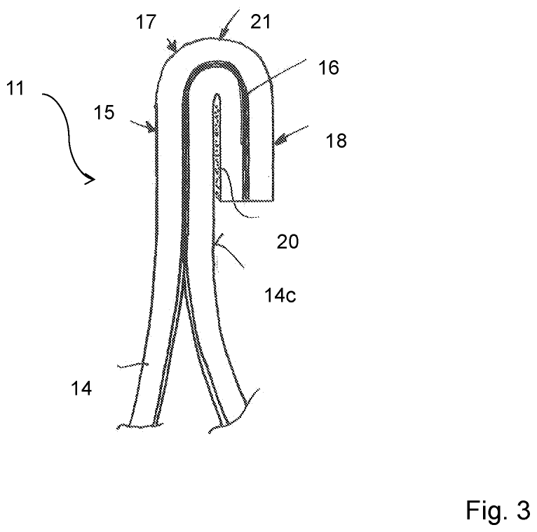

Closure region 17 having weld seam 16 is then folded over by 180° on a first fold edge 21 (cf. FIG. 3) in such a way that closure region 17 is divided into an unfolded base section 15 connected to tube body 11 and a foldover section 18, base section 15 being longer than foldover section 18. Foldover section 18 is then situated next to and essentially in parallel to base secti9n 15 on the outside thereof. During or after the formation of first fold edge 21, an adhesive 20 is applied in such a way that foldover section 18 is glued to an outer wall 14c of unfolded base section 15 of closure region 17. It is provided that foldover section 17 is connected only to unfolded base section 15 of closure region 17 and not to outer wall 14c of tube body 11 outside closure region 17. This state is shown in FIG. 3.

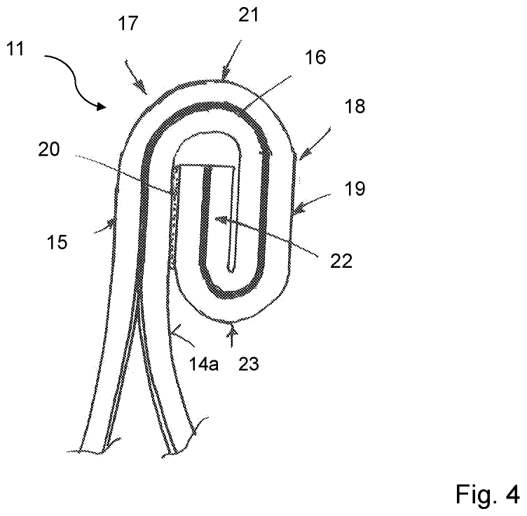

FIG. 4 shows an alternative embodiment of the closure of tube 11, in this case as well closure region 17 being folded over on first fold edge 21 in such a way that closure region 17 is divided into unfolded base section 15 connected to tube body 11 and foldover section 18. However, foldover section 18 is subsequently folded over again by 180° on a second fold edge 23 in such a way that foldover section 18 is divided into a foldover base section 19 connected to first fold edge 21 and a foldover end section 22. Foldover end section 22 of foldover section 18 is arranged between foldover base section 19 and base section 15 of closure region 17.

During or after the formation of second fold edge 23, foldover end section 22 is glued to unfolded base section 15 of closure region 17, using an adhesive glue, for example, a hot glue 20.

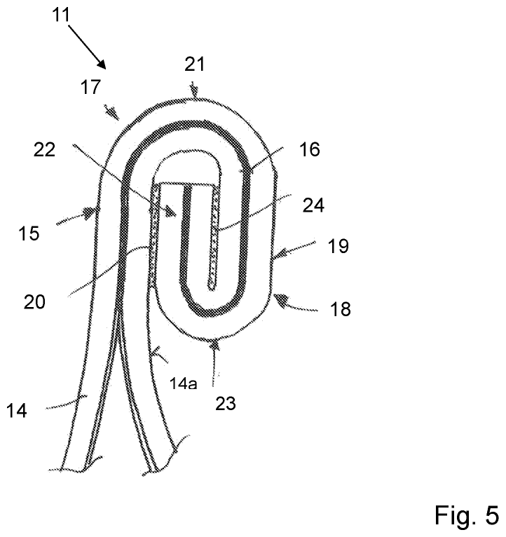

FIG. 5 shows an additional example of the embodiment according to FIG. 4 and differs therefrom in that foldover end section 22 is now also glued to foldover base section 19 with the aid of an adhesive layer 24.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A tube comprising:
a tube body that has a tube shoulder on a first axial end and is closed on an opposite second axial end;
a tube wall, wherein opposite sections of the tube wall of the tube body are welded to each other in a closure region,
wherein the closure region is folded over on a first fold edge such that the closure region is divided into an unfolded base section connected to the tube body and a foldover section, and
wherein the foldover section is glued only to the unfolded base section of the closure region.

2. The tube according to claim 1, wherein the tube wall includes a first layer made of paper, which is coated with a second layer made of plastic at least on one side.

3. The tube according to claim 1, wherein the foldover section is folded over on a second fold edge such that the foldover section is divided into a foldover base section connected to the first fold edge and a foldover end section, and wherein the foldover end section is glued to the unfolded base section of the closure region.

4. The tube according to claim 3, wherein the foldover end section of the foldover section is arranged between the foldover base section and the base section of the closure region.

5. The tube according to claim 4, wherein the foldover end section is glued to the foldover base section.

6. A method for closing a tube, the method comprising:
providing a tube body having a tube wall;
welding opposite sections of the tube wall of the tube body to each other in a closure region;
folding over the closure region after welding on a first fold edge such that the closure region is divided into an unfolded base section connected to the tube body and a foldover section; and
gluing the foldover section to the unfolded base section of the closure region.

7. The method according to claim 6, wherein the foldover section is folded over on a second fold edge such that the foldover section is divided into a foldover base section connected to the first fold edge and a foldover end section, and wherein the foldover end section is glued to the unfolded base section of the closure region.

8. The method according to claim 7, wherein the folded foldover end section of the foldover section is arranged between the foldover base section and the base section of the closure region.

9. The method according to claim 8, wherein the foldover end section is glued to the foldover base section.
